(19) United States
(12) Patent Application Publication
(10) Pub. No.: US 2024/0273391 A1
(43) Pub. Date: Aug. 15, 2024

(54) TWO-QUBIT GATES BETWEEN FLUX-TUNABLE MULTIMODE QUBITS

(71) Applicant: International Business Machines Corporation, Armonk, NY (US)

(72) Inventor: Aaron Finck, White Plains, NY (US)

(21) Appl. No.: 18/168,181

(22) Filed: Feb. 13, 2023

(51) Int. Cl. G06N 10/40; G06N 10/20; H10N 60/12; H10N 60/80

(52) U.S. Cl. CPC G06N 10/40; G06N 10/20; H10N 60/12; H10N 60/805

(57) ABSTRACT

An electronic structure can include a first superconducting quantum interference device (SQUID) coupled between a first pad and a second pad of a first tunable coupler qubit (TCQ) having a first qubit, and a first Josephson Junction (JJ) coupled between a second pad and a third pad of the first TCQ. The electronic structure can include a second SQUID coupled between a first pad and a second pad of a second TCQ having a second qubit, and a second JJ coupled between the second pad and a third pad of the second TCQ. The second pad of the first TCQ can be coupled to the second pad of the second TCQ. The first TCQ can be coupled to a first driveline, and the second TCQ can be coupled to a second driveline.

### BACKGROUND

The subject disclosure relates to quantum circuitry, and more specifically, to two-qubit gates between flux-tunable multi-mode qubits.

### SUMMARY

The following presents a summary to provide a basic understanding of one or more embodiments of the disclosed subject matter. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, structures, methods, apparatuses, and/or computer program products that can facilitate creating and/or utilizing two-qubit gates between flux-tunable multi-mode qubits, are presented.

According to an embodiment, a system can comprise a first Superconducting Quantum Interference Device (SQUID) coupled between a first pad and a second pad of a first tunable coupler qubit (TCQ). The first TCQ can also include a first Josephson Junction (JJ) coupled between the second pad and a third pad of the first TCQ. Additionally, the system can comprise a second SQUID coupled between a first pad and a second pad of a second TCQ. The second TCQ can include a second JJ coupled between the second pad and a third pad of the second TCQ. Further, the second pad of the first TCQ can be coupled to the second pad of the second TCQ. The first TCQ can be coupled to a first driveline, and the second TCQ can be coupled to a second driveline.

According to another embodiment, a system can comprise a first driveline that can be coupled to a first TCQ including a first qubit. The system can further comprise a second driveline coupled to a second TCQ including a second qubit. A first flux can be applied to the first TCQ via the first driveline, and a second flux can be applied to the second TCQ via the second driveline such that a controlled phase gate can be coupled between the first TCQ and the second TCQ.

According to another embodiment, a method of coupling a plurality of multi-mode qubits can comprise longitudinally coupling a first tunable coupler qubit (TCQ) with a second tunable coupler qubit (TCQ) to form a ZZ connection therebetween by operating the first TCQ at a first flux via a first driveline and operating the second TCQ at a second flux via a second driveline, wherein the first TCQ and the second TCQ can have direct capacitive coupling between a first middle pad of the first TCQ and a second middle pad of the second TCQ.

Advantages of the system can include that the system can enhance (e.g., increase, improve, or optimize) connectivity between quantum components (e.g., qubits or other quantum components), can enhance layout of electronic elements or quantum components of quantum circuitry, can reduce the quantity of drivelines coupled to the TCQ components (e.g., such that one driveline is coupled to each TCQ or qubit), and can enhance management of interactions or coupling between quantum components, which can include enhanced mitigation or suppression of undesired interactions, coupling, and entanglements between quantum components.

In some embodiments, elements described in connection with the disclosed systems can be embodied in different forms such as a device, a method, or another form.

These and other features will become apparent from the following detailed description of illustrative embodiments thereof, which is to be read in connection with the accompanying drawings.

### DESCRIPTION OF THE DRAWINGS

FIG. 1 illustrates a block diagram of an example, non-limiting system that can comprise a pair of quantum components and drivelines that can manage interaction or coupling between quantum components, in accordance with various aspects and embodiments of the disclosed subject matter.

FIG. 2 depicts a block diagram of example, non-limiting mode structures of modes of a quantum component, in accordance with various aspects and embodiments of the disclosed subject matter.

FIG. 3A depicts a diagram of an example, non-limiting system that can comprise a pair of quantum components that can manage interaction or coupling between qubits, in accordance with various aspects and embodiments of the disclosed subject matter.

FIG. 3B presents a diagram of an example, non-limiting graph illustrating magnetic field tuning the various modes for a system in a first state that can comprise a pair of quantum components that can manage interaction or coupling between qubits, in accordance with various aspects and embodiments of the disclosed subject matter.

FIG. 3C presents a diagram of an example, non-limiting graph illustrating magnetic field tuning the various modes for a system in a second state that can comprise a pair of quantum components that can manage interaction or coupling between qubits, in accordance with various aspects and embodiments of the disclosed subject matter.

FIG. 3D presents a diagram of an example, non-limiting graph illustrating magnetic field tuning the various modes for a system in a third state that can comprise a pair of quantum components that can manage interaction or coupling between qubits, in accordance with various aspects and embodiments of the disclosed subject matter. FIG. 4 presents a diagram of an example, non-limiting graph illustrating interaction between three TCQs associated with a variety of modes when one of the TCQs can be flux tuned to transition to an on state while the other TCQ can be maintained in an off state, in accordance with various aspects and embodiments of the disclosed subject matter.

FIG. 5 presents a diagram of an example, non-limiting graph illustrating interaction between three TCQs associated with a variety of modes when two of the TCQs can be flux tuned to an on state, in accordance with various aspects and embodiments of the disclosed subject matter.

FIG. 6 illustrates a flow diagram of an example, non-limiting method that can employ a pair of drivelines and TCQs to control interactions, coupling, or gates between the TCQs, in accordance with various aspects and embodiments of the disclosed subject matter.

FIG. 7 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum computers can comprise a group of qubits that can perform quantum operations on data. In quantum circuits comprising qubits, a coupler can be utilized to enable qubit-to-qubit interactions or couplings between a pair of qubits to create quantum logic gates. Couplers also can be used to enable interactions or couplings between other types of electronic elements in a quantum circuit.

With regard to interactions, couplings, and gates, to facilitate description of various aspects and embodiments of the disclosed subject matter, the following can provide definitions and/or context that may be relevant to the disclosed subject matter. An entangling gate can comprise an operation in which external fields (e.g., microwave pulses) can be applied to a quantum processor, comprising qubits, to create an entangled state between two or more separate qubits. A controlled-phase (CPHASE) gate can be a particular type of entangling gate in which one qubit can acquire a phase shift if and only if both qubits are in their first excited state.

A ZZ interaction can be a type of interaction between two qubits or modes in which the excitation of one qubit can cause a shift in the transition frequency of the other qubit or mode. Thus, the ZZ interaction can represent a way to entangle two different qubits and create a CPHASE gate because a state-dependent shift in qubit frequency can be made equivalent to a state-dependent phase shift. A ZZ interaction sometimes can be referred to as longitudinal coupling or can be denoted as chi or 2-chi. A static ZZ interaction can be a type of ZZ interaction that can be present between two qubits or modes in the absence of any external microwave drives (e.g., microwave pulses). The static ZZ interaction can be an “always-on” interaction that can be undesired (e.g., unwanted) and detrimental to a system of qubits by inhibiting independent control of each qubit and by created undesired entanglement.

An exchange interaction can be a type of interaction between quantum systems that can allow energy to be exchanged. If present between two qubits, applying microwave pulses to one qubit can potentially excite the other qubit, and thus, such an interaction can be an undesired form of crosstalk that can be detrimental to the quantum system.

With some existing quantum circuits and couplers, there can be an always-on interaction, such as a static ZZ interaction, between two qubits or modes, even in the absence of any external microwave drives. Such an always-on interaction can be undesirable and detrimental to a system of qubits, as it can inhibit independent control of each qubit and can create undesired (e.g., unwanted) entanglement between qubits.

It can be desirable to enhance (e.g., increase, improve, or optimize) the efficiency, reliability, and performance of coupler components, enhance connectivity between qubits (or other quantum components), and enhance layout of electronic elements of quantum circuitry. It also can be desirable to enhance the management of interactions and coupling between qubits (or other quantum components), including mitigating or suppressing undesired interactions, coupling, and entanglements between qubits (or other quantum components).

The disclosed subject matter comprises TCQ components and techniques that can have a number of advantages and can overcome the various deficiencies of existing TCQs and techniques. The disclosed TCQ components and techniques for coupling of TCQs can have enhanced (e.g., increased, improved, or optimized) efficiency, reliability, and performance, can enhance connectivity between qubits (or other quantum components), can enhance layout of electronic elements of quantum circuitry, can reduce the quantity of drivelines coupled to the TCQ components (e.g., such that a single driveline is coupled to each TCQ or qubit), can enhance management of interactions and coupling between qubits, including enhanced mitigation or suppression of undesired interactions, coupling, and entanglements between qubits (or other quantum components), as compared to existing couplers and techniques.

To that end, various embodiments described herein relate to techniques for managing coupling between qubits. In some embodiments, a system or device can comprise a first tuneable coupler qubit (TCQ) that can comprise a first mode (e.g., a first “A” mode) associated with a first frequency (e.g., a first mode of oscillation) and a second mode (e.g., a first “B” mode) associated with a second frequency (e.g., a second mode of oscillation). A TCQ also can be referred to as a TCQ coupler. The system or device also can comprise a second TCQ that can comprise a third mode (e.g., a second “B” mode) associated with a third frequency (e.g., a third mode of oscillation) and a fourth mode (e.g., a second “A” mode) associated with a fourth frequency (e.g., a fourth mode of oscillation). The first TCQ and the second TCQ can be associated with (e.g., selectively connected or coupled to) each other, for example, through direct capacitive coupling, a bus component, or via a co-planar waveguide (CPW), such as described herein.

The respective frequencies associated with the respective modes can be same as or different from each other. For instance, the first frequency associated with the first mode (e.g., first “A” mode) can be same as or different from the third frequency associated with the third mode (e.g., second “A” mode), and the second frequency associated with the second mode (e.g., first “B” mode) can be same as or different from the fourth frequency associated with the fourth mode (e.g., second “B” mode).

Respective magnetic fluxes can be applied to the first TCQ (e.g., a flux-tuneable SQUID of the first TCQ) and the second TCQ (e.g., a flux-tuneable SQUID of the second TCQ), which can result in a desired balance between the respective modes of the respective TCQs, and interaction and such fluxes can suppress undesirable coupling between the first TCQ and the second TCQ. For example, ZZ interaction or coupling, including static ZZ interaction, between the first TCQ and the second TCQ can be desirably suppressed, and an exchange interaction between the first TCQ and the second TCQ can be desirably suppressed for a wide range of frequencies, based on the mode-selective coupling (e.g., utilizing pairs of TCQs, such as the first TCQ and second TCQ).

When respective modified magnetic fluxes are applied to the first TCQ and the second TCQ to desirably adjust tuning of the respective TCQs (e.g., to adjust tuning of the respective SQUIDS of the respective TCQs), this can cause respective imbalances to occur in the first TCQ and the second TCQ (e.g., such as described herein), which can excite the respective modes of the first TCQ and second TCQ, and, and a result, a desired coupling can be created, wherein a ZZ interaction, an entangled interaction and gate, and/or a controlled-phase (CPHASE) gate can be created between the first TCQ and the second TCQ. A coupling may be defined as an interaction between two systems (e.g., between a first system, comprising a first qubit and/or a first TCQ, and a second system, comprising a second qubit and/or a second TCQ) strong enough to create a multi-qubit gate (e.g., between two qubits) and/or a desired exchange of information or energy between two electronic elements (e.g., electronic elements, which can be qubits, resonators, or other desired electronic elements or components).

These and other aspects and embodiments of the disclosed subject matter will now be described with respect to the drawings.

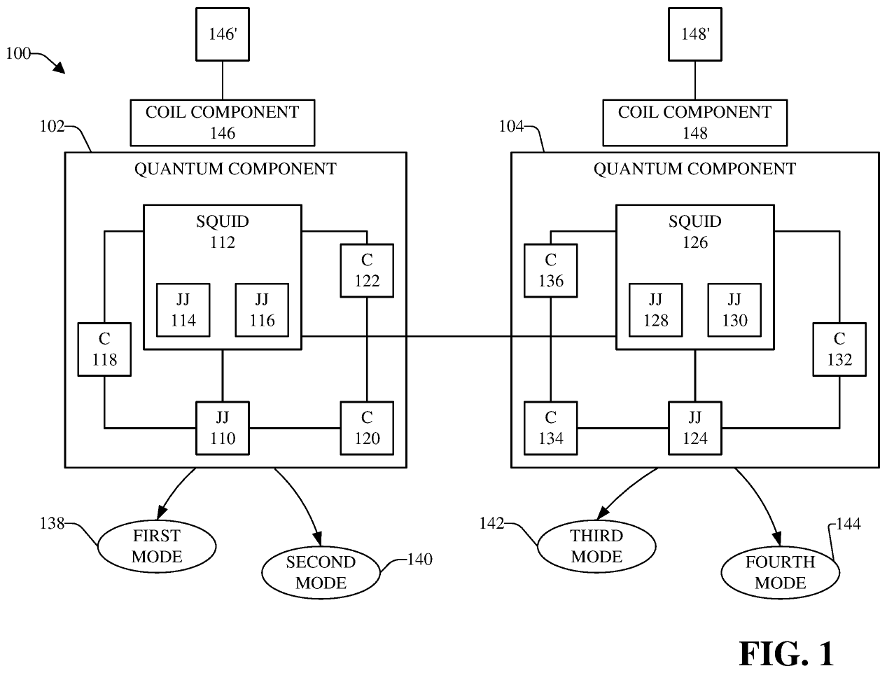

In embodiments, such as shown in FIG. 1, a non-limiting system 100 can comprise a pair of quantum components (e.g., TCQs). The system 100 can comprise various components and circuitry (e.g., quantum components and circuitry) that can be arranged to perform one or more desired functions, such as described herein. The system 100 can comprise or be part of, for example, a multi-qubit device or package that can have dimensions (e.g., the integrated circuit (IC) chip on which the system 100 can reside can have dimensions) that can vary, wherein the length of the device or package can range, for example, from on the order of millimeters to on the order of tens of millimeters, the width of the device or package can range, for example, from on the order of millimeters to on the order of tens of millimeters, and the thickness can range, for example, from approximately 1 millimeter (mm) to approximately 3 mm. It is to be appreciated and understood that these dimensions of the device or package are exemplary, and, in accordance with other embodiments, the device or package can have different (e.g., smaller or larger) dimensions than the example dimensions described herein.

In some embodiments, the system 100 can comprise a first quantum component 102 and a second quantum component 104 that can be formed as part of a quantum circuit, which can be formed on one or more chip stacks formed on one or more dies (e.g., IC chips). The first quantum component 102 and the second quantum component 104 can be part of a group of quantum components of a quantum computer (e.g., superconducting quantum computer). In certain embodiments, the first quantum component 102 and second quantum component 104 can be flux-tuneable coupler qubits (TCQs). A TCQ can comprise, for example, one of more Josephson junctions (JJs) and a shunt capacitor that can be associated with the one or more Josephson junctions.

It can be desired (e.g., wanted, needed, or suitable) to manage (e.g., control) interactions, couplings, and/or gates between quantum components, such as the first quantum component 102 and second quantum component 104. In accordance with various embodiments, interactions and coupling between the first quantum component 102 and second quantum component 104 can be enabled and managed via one or more drivelines. The one or more drivelines can control and enable quantum component-to-quantum component (e.g., qubit-to-qubit) interactions (e.g., interactions between the first quantum component 102 and second quantum component 104) that can allow for quantum logic gates or other desired types of interactions. In some embodiments, the first quantum component 102 and the second quantum component 104 can be coupled to each other using a coupling capacitor, such as more fully described herein.

In accordance with various embodiments, the first quantum component 102 and the second quantum component 104 can each be a TCQ (e.g., a flux-tuneable TCQ). For instance, the first quantum component 102 and the second quantum component 104 can be TCQs that can enable one or more parameters (e.g., frequency, or another desired parameter) to be desirably tuned (e.g., modified, adjusted, or changed) based on magnetic fluxes respectively applied to the first quantum component 102 and the second quantum component 104, such as more fully described herein.

The first quantum component 102 can comprise a JJ 110 and a SQUID 112 (e.g., flux-tuneable SQUID), wherein the SQUID 112 can comprise a JJ 114 and JJ 116. The CC 106 also can comprise a capacitor (C) 118, which can be a shunt capacitor that can be associated with the JJ 110 and SQUID 112, a capacitor 120 that can be associated with the JJ 110, and a capacitor 122 that can be associated with the SQUID 112. The second quantum component 104 can comprise a JJ 124 and a SQUID 126 (e.g., flux-tuneable SQUID), wherein the SQUID 126 can comprise a JJ 128 and JJ 130. The second quantum component 104 also can comprise a shunt capacitor 132 that can be associated with the JJ 124 and SQUID 126, a capacitor 134 that can be associated with the JJ 124, and a capacitor 136 that can be associated with the SQUID 126. Further, the first quantum component 102 can store quantum information (e.g., qubit information, quantum state information, etc.) in the first mode of oscillation (e.g., A mode, the first mode 138) and the second quantum component 104 can store quantum information in the third mode of oscillation (e.g., A mode, the third mode 142). In such manner, the first quantum component 102 (e.g., the first TCQ) and the second quantum component 104 (e.g., the second TCQ) can be used as qubits by utilizing the first mode 138 and the third mode 142 for storing quantum information.

In the first quantum component 102, the JJ 110 and SQUID 112 can be structured, designed, and/or arranged in the quantum circuit in relation to each other such that multiple modes of oscillation can be created, where the multiple modes can comprise a first mode (e.g., “A” mode) of oscillation 138 and a second mode (e.g., “B” mode) of oscillation 140. The first mode of oscillation 138 can be associated with a first frequency, and the second mode of oscillation 140 can be associated with a second frequency. The second frequency associated with the second mode 140 typically can be higher than the first frequency associated with the first mode 138. The second mode 140 also can be referred to as a dark mode because it typically may have no net dipole moment. The first mode 138 and second mode 140 can be two distinct modes that can correspond to symmetric and antisymmetric combinations of excitations associated with the JJ 110 and SQUID 112.

Similarly, in the second quantum component 104, the JJ 124 and SQUID 126 can be structured, designed, and/or arranged in the quantum circuit in relation to each other such that multiple modes of oscillation can be created, where the multiple modes can comprise a third mode (e.g., another “B” mode) of oscillation 142 and a fourth mode (e.g., another “A” mode) of oscillation 144. The third mode 142 can be associated with a third frequency, which can be different from or same as the second frequency associated with the second mode 140. The fourth mode 144 can be associated with a fourth frequency, which can be different from or same as the first frequency associated with the first mode 138. The third frequency associated with the third mode 142 typically can be higher than the fourth frequency associated with the fourth mode 144. The third mode 142 also can be referred to as a dark mode because it typically may have no net dipole moment. The third mode 142 and fourth mode 144 can be two distinct modes that can correspond to symmetric and antisymmetric combinations of excitations associated with the JJ 124 and SQUID 126.

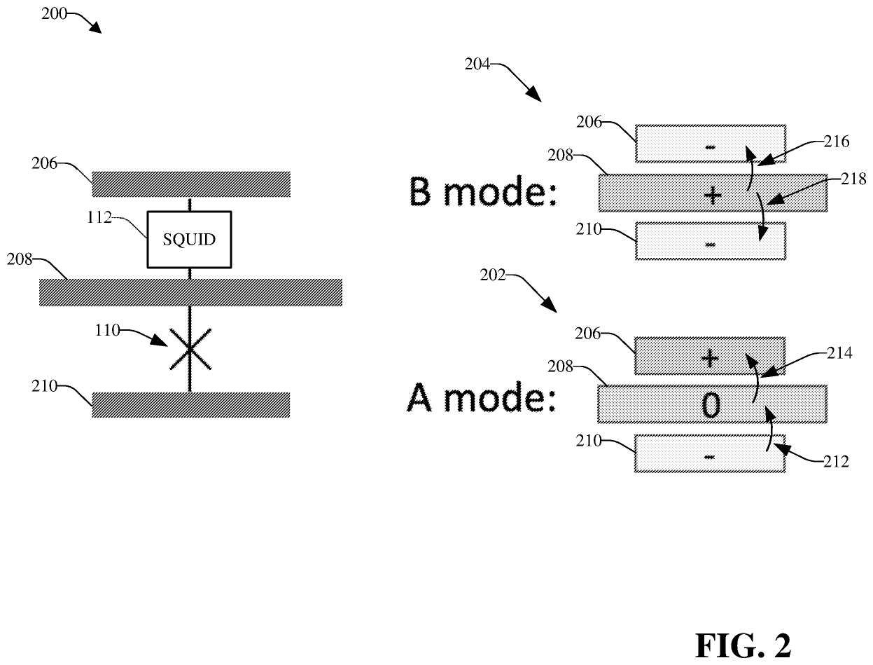

Turning to FIG. 2 (along with FIG. 1), FIG. 2 depicts a block diagram of example, non-limiting mode structures 200 of the modes of a quantum component (e.g., the first quantum component 102 and the second quantum component 104), in accordance with various aspects and embodiments of the disclosed subject matter. The mode structures 200 can comprise an “A” mode structure 202 of the “A” mode (e.g., first mode 138) and a “B” mode structure 204 of the “B” mode (e.g., second mode 140) of the first quantum component 102.

The JJ 110 and the SQUID 112 of the first quantum component 102 (e.g., flux-tuneable TCQ) can be associated with (e.g., connected to) respective capacitor pads (e.g., capacitor plates), such as capacitor pads 206, 208, and 210, of respective capacitors of the first quantum component 102. As shown in the “A” mode structure 202, in the “A” mode of the first quantum component 102, charge can flow from the capacitor pad 210 to the capacitor pad 208 (as indicated at reference numeral 212), and the charge also can flow in the same direction from the capacitor pad 208 to the capacitor pad 206 (as indicated at reference numeral 214). As a result, no net charge is accumulating in the capacitor pad 208, and the first quantum component (e.g., SQUID 112) can be symmetric or antisymmetric, depending on how the direction of the charge is defined. As shown in the “B” mode structure 204, in the “B” mode of the first quantum component 102, charge can flow from the capacitor pad 208 to the capacitor pad 206 and the capacitor pad 210 (as indicated at reference numerals 216 and 218, respectively).

With further regard to FIG. 1, in some embodiments, the first quantum component 102 can be selectively coupled to the second quantum component 104 by applying flux to SQUID 112 and SQUID 126 via one or more drivelines such that a ZZ interaction can form a CPHASE gate between the first mode 138 (e.g., A mode of the first quantum component 102) and the third mode 142 (e.g., A mode of the second quantum component 104).

Using the respective SQUIDs 112 and 126, the first quantum component 102 and the second quantum component 104 can be desirably tuned to facilitate exciting, or not exciting, their respective modes (e.g., 138, 140, 142, 144), which can result in managed interactions, coupling, and gates between the first quantum component 102 and second quantum component 104.

To facilitate tuning the first quantum component 102 and the second quantum component 104, the system 100 can comprise a first coil component 146 (e.g., connected with a first driveline 146′) that can be associated with and in proximity to the first quantum component 102 and/or SQUID 112, and a second coil component 148 (e.g., connected with a second driveline 148′) that can be associated with and in proximity to the second quantum component 104 and/or SQUID 126. The first coil component 146 can be employed to apply a desired magnetic field or flux to the first quantum component 102 (e.g., to the SQUID 112) based on a current supplied to the first coil component 146 via the first driveline 146′ . The second coil component 148 can be employed to apply a desired magnetic field or flux to the second quantum component 104 (e.g., to the SQUID 126) based on a current supplied to the second coil component 148 via the second driveline 148′. The magnetic field created and applied by the second coil component 148 can be different from or same as the magnetic flux created and applied by the first coil component 146, depending in part on the respective characteristics (e.g., characteristics of a barrier of a JJ, characteristics of the materials of components, inductance, impedance, or other characteristics) of or associated with the respective components (e.g., Hs, SQUIDS, or other components) of the first quantum component 102 and the second quantum component 104. Further, the first coil component 146 can apply a first magnetic flux to the SQUID 112 via the first driveline 146′, and the second coil component 148 can apply a second magnetic flux to the SQUID 126 via the second driveline 148′. The first magnetic flux applied by the first driveline 146′ can be substantially the same as or substantially different than the second magnetic flux applied by the second driveline 148′.

Under certain magnetic fluxes applied to the first quantum component 102 and the second quantum component 104, the respective modes (e.g., 138, 140, 142, 144) can be maintained in or transitioned to a non-excited state, which can suppress coupling between the first quantum component 102 and second quantum component 104 and/or suppress interaction or coupling between respective components (e.g., between the first quantum component 102 and the second quantum component 104) of the system 100.

For instance, the first coil component 146 can apply a first amount of magnetic flux to the SQUID 112 of the first quantum component 102 via the first driveline 146′ that can cause a critical current of the SQUID 112, and accordingly, a first energy (e.g., first Josephson energy) associated with the SQUID 112, to be close, equal, or substantially similar to a critical current of the JJ 110 of the first quantum component 102, and accordingly, a second energy (e.g., second Josephson energy) associated with the JJ 110. Additionally, the second coil component 148 can apply a second amount of magnetic flux to the SQUID 126 of the second quantum component 104 that can cause a critical current of the SQUID 126, and accordingly, a third energy (e.g., third Josephson energy) associated with the SQUID 126, to be close, equal, or at least substantially similar to a critical current of the JJ 124 of the second quantum component 104, and accordingly, a fourth energy (e.g., fourth Josephson energy) associated with the JJ 124. As a result, there can be a balancing of the first energy and the second energy associated with the first quantum component 102, and a balancing of the third energy and the fourth energy associated with the second quantum component 104, which can provide and/or enforce desired mode-selective coupling associated with the first quantum component 102 and the second quantum component 104, and which can thereby cause or create a desired suppression (e.g., squelching) of interaction or coupling (e.g., ZZ, static ZZ, and/or exchange interaction or coupling) between the first quantum component 102 and second quantum component 104 to essentially or approximately zero interaction or coupling.

If the magnetic fluxes applied to the SQUID 112 and SQUID 126 by the first coil component 146 and the second coil component 148 are modified (e.g., changed or adjusted) to certain respective amounts of magnetic flux to adjust the tuning of the first quantum component 102 and the second quantum component 104 (e.g., adjust the tuning associated with the SQUID 112 and SQUID 126), the respective modes (e.g., 138, 140, 142, 144) can be transitioned to an excited state, which can allow a desired interaction or coupling between the first quantum component 102 and second quantum component 104 (as well as interaction or coupling between the first mode 138, the second mode 140, the third mode 142, and/or the fourth mode 144 to store and/or transmit quantum/qubit information).

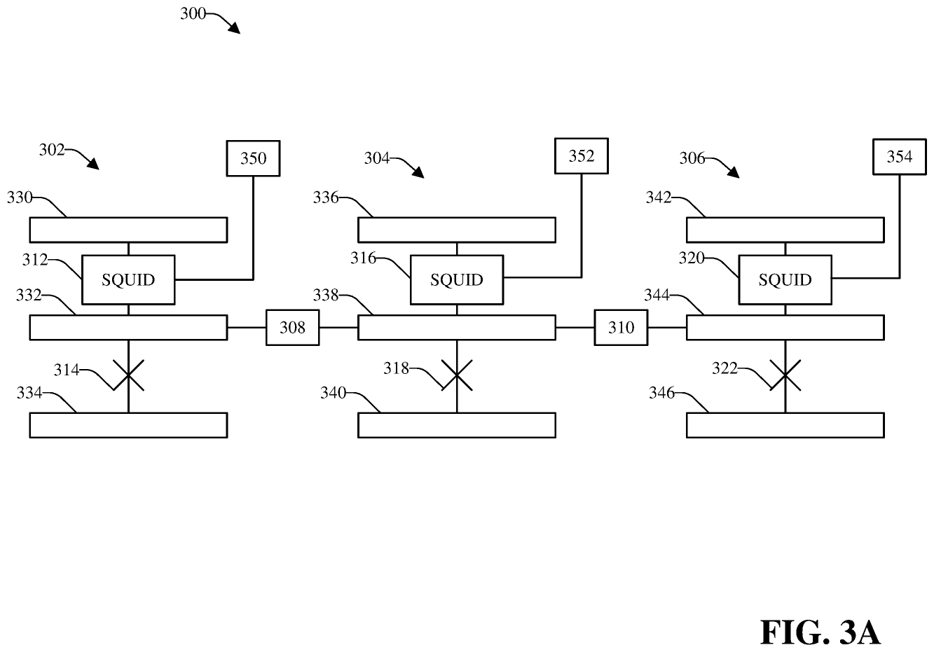

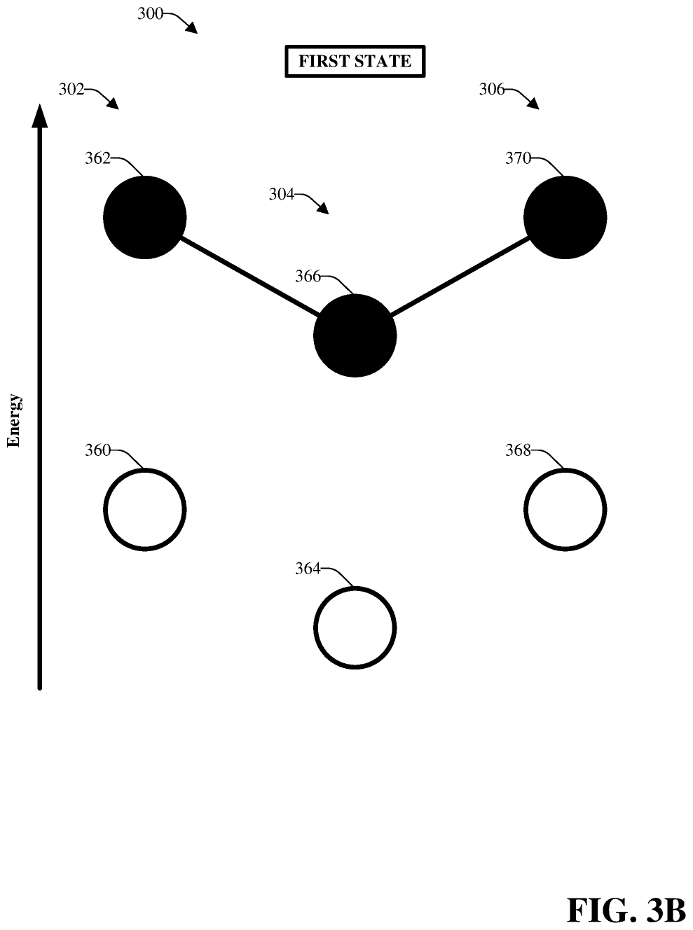

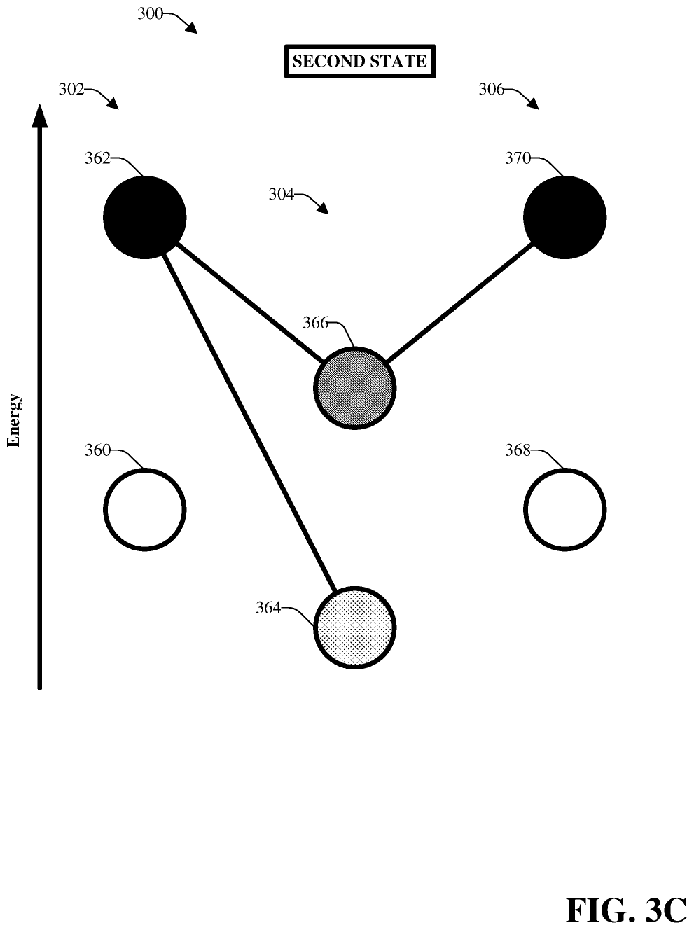

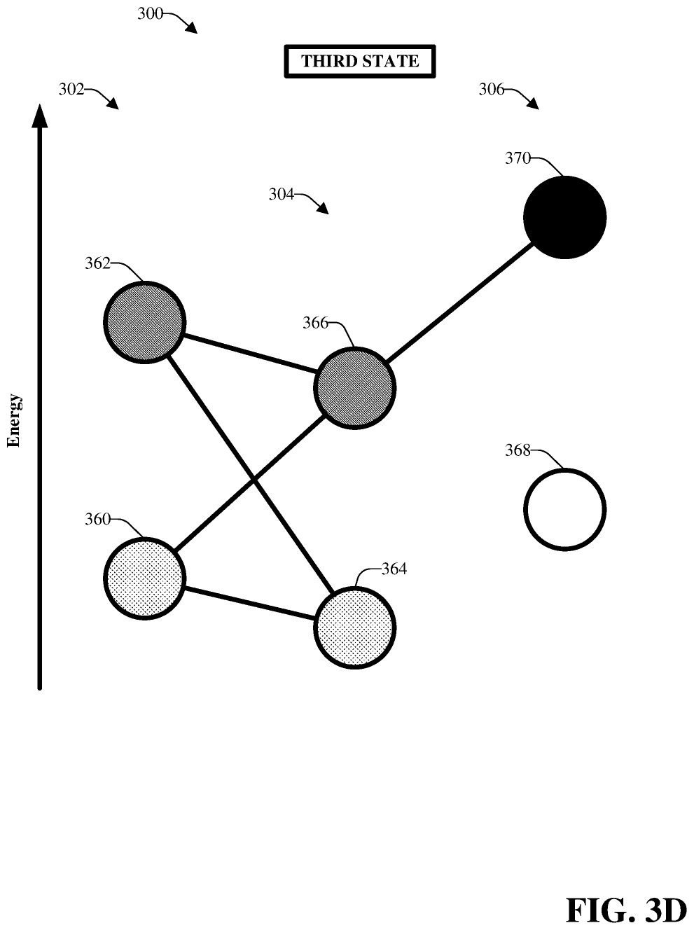

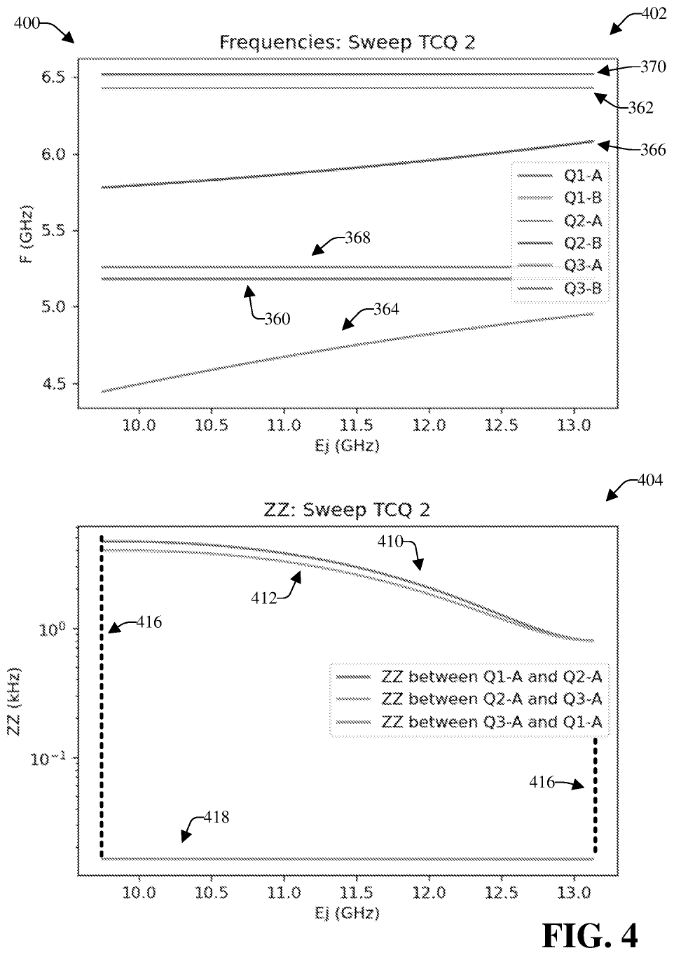

For example, and without limitation, a ZZ interaction can be activated between the first quantum component 102 and the second quantum component 104 by applying a first modified amount of magnetic flux via the first driveline 146′ and applying a second modified amount of magnetic flux via the second driveline 148′ (e.g., such that energies of the SQUID 112 and SQUID 126 can be altered). Further, a ZZ interaction can be activated between the first quantum component 102 and the second quantum component 104 by applying the second modified amount of magnetic flux via the second driveline 148′ to the second quantum component 104 to lower the third energy (e.g., Josephson energy, E J) of the SQUID 126. Applying the second modified amount of magnetic flux can lower the third energy from about 13.13 GHz to about 9.75 GHz. Lowering the third energy of the SQUID 126 can cause the third mode of oscillation 142 and the fourth mode of oscillation 144 to decrease in frequency and change spatial configuration (e.g., as generally illustrated in FIGS. 4, 5, and 6). The ZZ interaction can further be activated between the first quantum component 102 and the second quantum component 104 by applying the first modified amount of magnetic flux via the first driveline 146′ to the first quantum component 102 to lower the first energy of the SQUID 112. For example, and without limitation, applying the first modified amount of magnetic flux can lower the first energy to a value of about 10.5 GHz (e.g., which can be shown by varying the Josephson energy, EJ, across a desired sweep range). Applying the second modified amount of magnetic flux and the first modified amount of magnetic flux can increase the ZZ interaction (e.g., vastly enhance) between the first quantum component 102 (e.g., the first TCQ) and the second quantum component 104 (e.g., the second TCQ) to a value greater than about 3 MHz, while the ZZ interaction between an additional quantum component coupled with the second quantum component 104 (e.g., as shown in FIG. 3) can be less than about 10 kHz. Further, the enhanced ZZ interaction between the first quantum component 102 and the second quantum component 104 can allow a CPHASE gate to be realized/generated therebetween.

Turning next to FIG. 3A, FIG. 3A illustrates a diagram of an example, non-limiting system 300 that can comprise a first TCQ, a second TCQ, and a third TCQ (e.g., a third, spectator TCQ/qubit with respect to the first TCQ and the second TCQ), in accordance with various aspects and embodiments of the disclosed subject matter. The system 300 can comprise a first TCQ 302, a second TCQ 304, and a third TCQ 306 that can be formed as part of a quantum circuit, which can be formed on one or more chip stacks formed on one or more dies (e.g., IC chips). The first TCQ 302 can be coupled with the second TCQ 304 via direct capacitive coupling (e.g., pad to pad) or a CPW resonator (e.g., coupling element 308 in a pad to line to pad coupling arrangement). Similarly, the second TCQ 304 can be coupled with the third TCQ 306 via direct capacitive coupling (e.g., pad to pad) or a CPW resonator (e.g., coupling element 310 in a pad to line to pad coupling arrangement).

With embodiments, the first TCQ 302 can comprise a JJ 314 and a SQUID 312, which can be associated with (e.g., connected to) the JJ 314. The first TCQ 302 can include a first pad 330, a second pad 332 (e.g., a middle pad), and a third pad 334. The SQUID 312 can be coupled between the first pad 330 and the second pad 332, and the JJ 314 can be coupled between the second pad 332 and the third pad 334. The second TCQ 304 can comprise a JJ 318 and a SQUID 316, which can be associated with (e.g., connected to) the JJ 318. The second TCQ 304 can include a first pad 336, a second pad 338 (e.g., a middle pad), and a third pad 340. The SQUID 316 can be coupled between the first pad 336 and the second pad 338, and the JJ 318 can be coupled between the second pad 338 and the third pad 340. The third TCQ 306 can comprise a JJ 322 and a SQUID 320, which can be associated with (e.g., connected to) the JJ 322. The third TCQ 306 can include a first pad 342, a second pad 344 (e.g., a middle pad), and a third pad 346. The SQUID 320 can be coupled between the first pad 342 and the second pad 344, and the JJ 322 can be coupled between the second pad 344 and the third pad 346.

In embodiments, the SQUID 312 of the first TCQ 302 can be coupled to a first driveline 350. The first driveline 350 can terminate in a coil substantially proximate the SQUID 312 such that current flowing through the first driveline 350 can generate a localized magnetic field around the SQUID 312. The first driveline 350 can provide current that can tune the magnetic flux enclosed by the SQUID 312. By the first driveline 350 changing the Josephson energy of the SQUID 312, the first driveline 350 can change the energy levels and symmetry of the associated qubit states (e.g., such that quantum information can be stored within the A modes of the first TCQ 302, the second TCQ 304, and/or the third TCQ 306).

With embodiments, the SQUID 316 of the second TCQ 304 can be coupled to a second driveline 352. The second driveline 352 can terminate in a coil substantially proximate the SQUID 316 such that current flowing through the second driveline 352 can generate a localized magnetic field around the SQUID 316. The second driveline 352 can provide current that can tune the magnetic flux enclosed by the SQUID 316. By the second driveline 352 changing the Josephson energy of the SQUID 316, the second driveline 352 can change the energy levels and symmetry of the associated qubit states (e.g., such that quantum information can be stored within the A modes of the first TCQ 302, the second TCQ 304, and/or the third TCQ 306).

Additionally, in embodiments, the SQUID 320 of the third TCQ 306 can be coupled to a third driveline 354. The third driveline 354 can terminate in a coil substantially proximate the SQUID 316 such that current flowing through the third driveline 354 can generate a localized magnetic field around the SQUID 320. The third driveline 354 can provide current that can tune the magnetic flux enclosed by the SQUID 320. By the third driveline 354 changing the Josephson energy of the SQUID 320, the third driveline 354 can change the energy levels and symmetry of the associated qubit states (e.g., such that quantum information can be stored within the A modes of the first TCQ 302, the second TCQ 304, and/or the third TCQ 306).

In embodiments, the first TCQ 302 can comprise a first mode 360 (e.g., an “A” mode) associated with a first frequency and a second mode 362 (e.g., a “B” mode) associated with a second frequency. The second TCQ 304 can comprise a third mode 364 (e.g., another “A” mode) associated with a third frequency and a fourth mode 366 (e.g., another “B” mode) associated with a fourth frequency. The third TCQ 306 can comprise a fifth mode 368 (e.g., another “A” mode) associated with a fifth frequency and a sixth mode 370 (e.g., another “B” mode) associated with a sixth frequency.

With embodiments, such as generally shown in FIGS. 3B, 3C, and 3D, the system 300 can be in a first state, a second state, or a third state. The first state can correspond to an “off” state where the first modified amount of magnetic flux and the second modified amount of magnetic flux are not applied to the first TCQ 302 or the second TCQ 304 (e.g., such as generally illustrated by FIG. 3B). When the system 300 is in the first state, the second mode 362, the fourth mode 366, and the sixth mode 370 can include exchange interactions therebetween. For example, the second mode 362 of the first TCQ 302 can be coupled with the fourth mode 366 of the second TCQ 304; and the fourth mode 366 of the second TCQ 304 can be coupled with the sixth mode 370 of the third TCQ 306. With examples, the system 300 can include any number of additional quantum components connected (e.g., with coupled neighboring “B modes”) in a similar manner as the first TCQ (first quantum component) 302, the second TCQ (the second quantum component) 304, and a third TCQ (third quantum component) 306. In embodiments, the first mode 360, the third mode 364, and the fifth mode 368 can be coupled to no additional quantum components, nor to each other such as to cause negligible cross-talk between the modes (the first mode 360, the third mode 364, and the fifth mode 368).

Further, in embodiments as shown in FIG. 3C, the second sate can correspond to an “intermediate” state where the second modified amount of magnetic flux can be applied to the second TCQ 304 (e.g., SQUID 316) and the first modified amount of magnetic flux can be prevented from being applied to the first TCQ 302 (e.g., SQUID 312). Applying the second modified amount of magnetic flux to the second TCQ 304 (e.g., SQUID 316) can lower the E_{J} of the SQUID 316 and can change the spatial configurations of the third mode 364 and the fourth mode 366 of the second TCQ 304. When the system 300 is in the second state, the spatial configuration change of the second TCQ 304 can cause the second mode 362 (e.g., of the first TCQ 302) to include exchange interactions with the third mode 364 and the fourth mode 366 (e.g., of the second TCQ 304), as illustrated in FIG. 3C with connecting line segments between modes. Applying the second modified amount of magnetic flux to the second TCQ 304 can decrease the frequencies and energies of the third mode 364 and the fourth mode 366 (e.g., the A mode and the B mode of the second TCQ 304).

In further embodiments, such as generally illustrated in FIG. 3D, the third state can correspond to an “on” state where the second modified amount of magnetic flux can be applied to the second TCQ 304 and the first modified amount of magnetic flux can be applied to the first TCQ 302. Applying magnetic flux via both the first driveline 146′ and the second driveline 148′ can cause the ZZ interaction between the first mode 360 (the A mode of the first TCQ 302) and the third mode 364 (the A mode of the second TCQ 304) to be enhanced, such that a CPHASE gate is realized between. Further, the first driveline 146′ can apply the first modified amount of magnetic flux, which can be determined by applying enough magnetic flux such that the third frequency (e.g., the frequency of the A mode of the second TCQ 304) is substantially the same as a transition frequency of the first state to the second excited state of the first TCQ 302 (e.g., substantially the same as the exchange coupling frequency, within about 100 MHz or more or less). For example, one or more JJs of the system 300 can include a port and a deactivated inductor, from which variables, such as s-parameters and impedances can be calculated. Further, Josephson energies can be assigned to the various JJs and the system 300 can be quantized (e.g., evaluating the system 300 as a quantum mechanical system) to determine energy levels and ZZ coupling between various modes of the TCQs.

In examples, when the system 300 is in the third state, the frequency shift of the first TCQ 302 can cause additional exchange interactions with the first mode 360 and the second mode 362 (e.g., of the first TCQ 302). As a result, the first mode 360 can include exchange interactions with the third mode 364 and the fourth mode 366. Additionally, the second mode 362 can include exchange interactions with the third mode 364 and the fourth mode 366. The first mode 360 can include exchange interactions with the fourth mode 366.

Referring to FIG. 4, FIG. 4 illustrates a diagram of example graphs 400 relating to coupling the first TCQ 302 with the second TCQ 304 over a desired sweep range (e.g., which is in turn coupled to a third TCQ 306) which are connected by direct capacitive coupling or a CPW, in accordance with various aspects and embodiments of the disclosed subject matter. A coupling may be defined as an interaction between two systems (e.g., between a first system, comprising a first TCQ 302, and a second system, comprising a second TCQ 304) strong enough to create a multi-qubit gate (e.g., between two qubits stored in the A modes of the first TCQ 302 and the second TCQ 304) and/or a desired exchange of information or energy between two electronic elements (e.g., qubits, resonators, or other desired electronic elements or components).

With embodiments, the graphs 400 can comprise graph 402 relating to frequencies (F), in GHz, associated with the modes of the TCQs (e.g., 360, 362, 364, 366, 368, 370) and modes as a function of Josephson energies, Eⱼ, in GHz for the system in the second state (“intermediate” state). The graphs 400 also can comprise graph 404 relating to ZZ interaction, in kHz, between the TCQs (e.g., 302, 304, 306) as a function of Josephson energies, Eⱼ, in GHz. The ZZ interaction between the first mode 360 and the third mode 364 is illustrated by plot 410. Additionally, a similar ZZ interaction can be seen between the third mode 364 and the fifth mode 368 as illustrated by plot 412; and the ZZ interaction between the fifth mode 368 and the first mode 360 can be illustrated by plot 414. As can be seen from FIG. 4, graph 404 and plot 414 illustrate a lack of coupling between the first TCQ 302 and the third TCQ 306 due to selective coupling controlled by the first driveline 146′ and the second driveline 148′ applying flux to the SQUID 312 and SQUID 316. Additionally, the first line segment 416 indicates the E_{J} of the second TCQ 304 when the system 100 is in the first state (e.g., the “off” state). The second line segment 418 indicates the E_{J} of the second TCQ 304 when the system 100 is in the second state (the “intermediate” state). As illustrated, the second modified amount of magnetic flux can be applied to the second TCQ 304 via the second driveline 148′, which can reduce the EJ of the SQUID 316 from about 13.13 GHz to about 9.75 GHz or more or less.

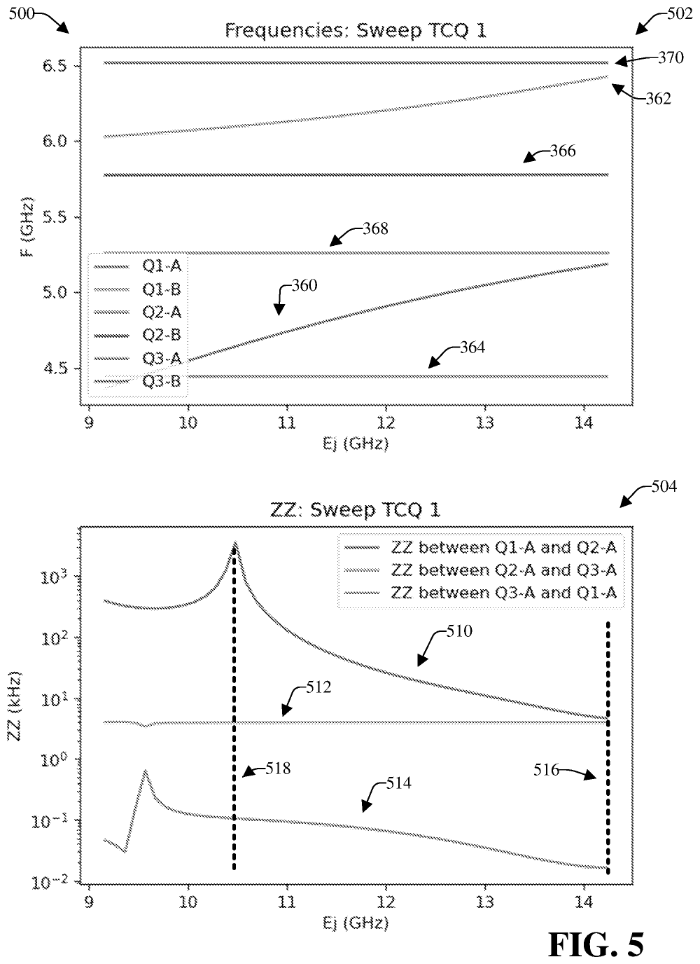

In embodiments, FIG. 5 illustrates a diagram of example graphs 500 relating to coupling the first TCQ 302 with the second TCQ 304 over a desired sweep range in the third state, in accordance with various aspects and embodiments of the disclosed subject matter. The graphs 500 can comprise graph 502 relating to frequencies (F), in GHz, associated with the modes of the TCQs (e.g., 360, 362, 364, 366, 368, 370) and modes as a function of Josephson energies, Eⱼ, in GHz for the system in the third state (“on” state). The graphs 400 also can comprise graph 404 relating to ZZ interaction, in kHz, between the TCQs (e.g., 302, 304, 306) as a function of Josephson energies, Eⱼ, in GHz. The ZZ interaction between the first mode 360 and the third mode 364 is illustrated by plot 510. Additionally, a similar ZZ interaction can be seen between the third mode 364 and the fifth mode 368 as illustrated by plot 512; and the ZZ interaction between the fifth mode 368 and the first mode 360 can be illustrated by plot 514. The third line segment 516 indicates the Eⱼ of the first TCQ 302 when the system is in the first state (e.g., the “off” state). The fourth line segment 518 indicates the E_{J} of the first TCQ 302 when the system is in the third state (the “on” state). As illustrated, the first modified amount of magnetic flux can be applied to the first TCQ 302 via the second driveline 148′, which can reduce the EJ of the SQUID 312 about 10.5 GHz or more or less. Applying the first modified amount of magnetic flux can increase the ZZ interaction between the first TCQ 602 and the second TCQ 604 to a value greater than about 3 MHz, while the ZZ interaction between the second TCQ 604 and the third TCQ 606 can be less than about 10 kHz. Quantum information (e.g., qubit information) can then be stored in the first mode 360 and the third mode 364 without interference from the fifth mode 368 and/or the sixth mode 370.

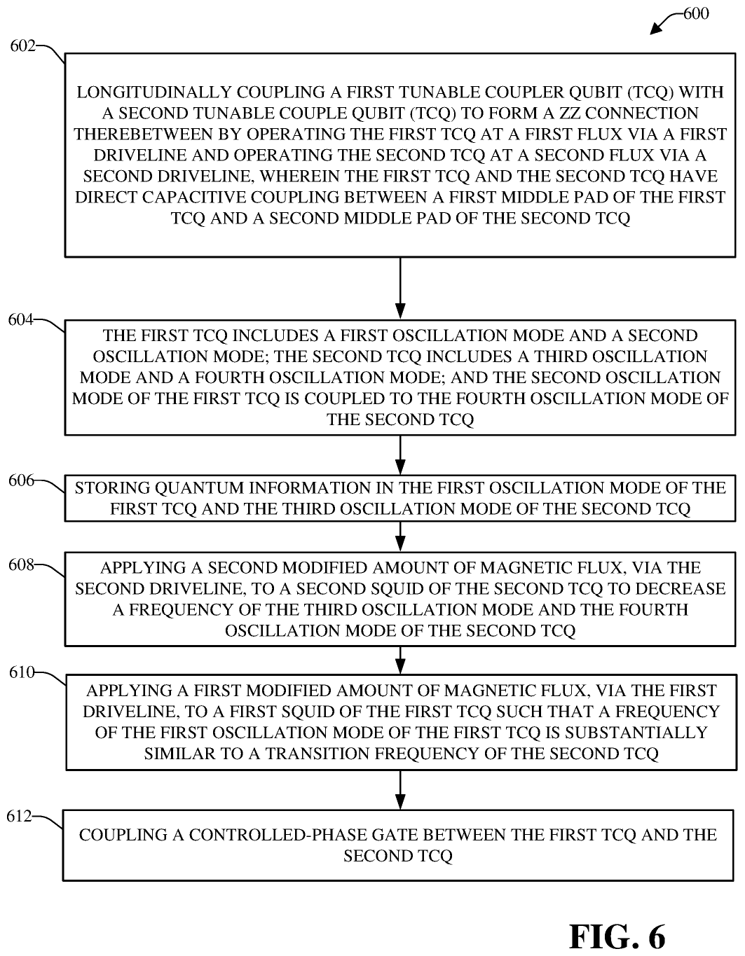

FIG. 6 illustrates a flow diagram of an example, non-limiting method 600 that can couple a first TCQ with a second TCQ, such that quantum information can be stored in a first mode of the first TCQ and in a third mode of the second TCQ, in accordance with various aspects and embodiments of the disclosed subject matter. The method 700 can be performed by, for example, a system comprising a pair of TCQs or any number of TCQs. Repetitive description of like elements employed in other embodiments described herein is or may be omitted for the sake of brevity.

At 602, the method 600 can include longitudinally coupling a first TCQ with a second TCQ to form a ZZ connection therebetween by operating the first TCQ at a first flux via a first driveline and operating the second TCQ at a second flux via a second driveline, wherein the first TCQ and the second TCQ have direct capacitive coupling between a first middle pad of the first TCQ and a second middle pad of the second TCQ.

In some embodiments, the first TCQ can include a first mode (A mode, first oscillation mode) and a second mode (B mode, second oscillation mode); and similarly, the second TCQ can include a third mode (second A mode, third oscillation mode) and a fourth mode (second B mode, fourth oscillation mode). The first TCQ can include a first SQUID and a first JJ; and the second TCQ can include a second SQUID and a second JJ. The first driveline can apply a first magnetic flux to the first SQUID of the first TCQ such that a sum of the critical currents of the first SQUID (e.g., the two JJs within the SQUID) is substantially similar to a critical current of the first JJ (e.g., substantially similar can be equal to or close such that at zero flux the second mode and the fourth mode of the first TCQ and the second TCQ can be coupled). Similarly, the second driveline can apply a second magnetic flux to the second SQUID of the second TCQ such that a sum of the critical currents of the second squid (e.g., the two JJs within the SQUID) is substantially similar to a critical current of the second JJ (e.g., substantially similar can be equal to or close such that at zero flux the second mode and the fourth mode of the first TCQ and the second TCQ can be coupled). The first TCQ can be selectively coupled to the second TCQ by applying flux to the first SQUID and the second SQUID via the first driveline and the second driveline such that a ZZ interaction can form a CPHASE gate between the first mode and the third mode.

The method 600 can include tuning the first TCQ and the second TCQ by applying flux to the first SQUID and the second SQUID. The first SQUID and the second SQUID can tune (e.g., by applying flux) the first TCQ and the second TCQ to facilitate exciting, or not exciting, their respective modes which can result in managed interactions, coupling, and gates between the first TCQ and the second TCQ. A first coil component can apply a first magnetic flux to the first SQUID via the first driveline, and the second coil component can apply a second magnetic flux to the second SQUID via the second driveline. The first magnetic flux and the second magnetic flux can be substantially the same or substantially different. The first coil component can apply a first amount of magnetic flux to the first SQUID that can cause a critical current of the first SQUID, and accordingly a first energy associated with the first SQUID to be equal or at least substantially equal to a critical current of the first JJ and a second energy associated with the first JJ. The second coil component can apply a second amount of magnetic flux to the second SQUID that can cause a critical current of the second SQUID, and accordingly a third energy associated with the second SQUID to be equal or at least substantially equal to a critical current of the second JJ and a fourth energy associated with the second JJ. The method 600 can comprise balancing the first energy and the second energy associated with the first TCQ and balancing the third energy and the fourth energy associated with the second TCQ, which can provide the desired mode-selective coupling associated with the first TCQ and the second TCQ. Further, balancing of the energies above can cause a desired suppression of interaction or coupling between the first TCQ and the second TCQ.

At 604, the method 600 can include the coupling the second oscillation mode of the first TCQ to the fourth oscillation mode of the second TCQ, at zero flux. For example, and without limitation, the B modes of the first TCQ and the second TCQ can be coupled together (e.g., to neighboring TCQs via the middle pad).

At 606, the method 600 can include storing quantum information (qubit information) in the first oscillation mode (A mode) of the first TCQ and in the third oscillation mode (A mode) of the second TCQ. In such a manner, the TCQs can be used as qubits (e.g., as a first qubit and a second qubit) within the system and thus do not require connection to a coupler element for additional control. Further, an advantage of coupling the first driveline with the first SQUID and the second driveline with the second SQUID can be that the system utilizes a single driveline (e.g., flux line) per qubit (e.g., TCQ) for state manipulation and coupling.

At 608, the method 600 can include applying a second modified amount of magnetic flux, via the second driveline, to the first SQUID of the first TCQ to decrease a frequency of the third oscillation mode and the fourth oscillation mode of the second TCQ. The second modified amount of magnetic flux can be an amount that reduces the E_{J} of the second TCQ from a value of about 13.13 GHz to a value of about 9.75 GHz (e.g., decreasing the energy level, decreasing the frequency, and altering the spatial configuration).

At 610, the method 600 can include applying a first modified amount of magnetic flux, via the first driveline, to a first SQUID of the first TCQ such that a frequency of the first oscillation mode of the first TCQ is substantially similar to a transition frequency of the second TCQ. The method 600 can include reducing the E_{J} of the first TCQ to a value of about 10.5 GHz (or more or less). Applying the first amount of magnetic flux to the first TCQ can increase the ZZ interaction between the first TCQ and the second TCQ to a value greater than about 3 MHz (or more or less).

At 612, the method 600 can include coupling a controlled-phase gate between the first TCQ and the second TCQ. Further, the ZZ interaction between the first oscillation mode and the third oscillation mode can be vastly/greatly enhanced which can provide for the CPHASE gate to be realized. In addition, the application of flux via the first driveline and/or the second driveline can be removed/prevented to turn off the ZZ interaction between the first oscillation mode and the third oscillation mode.

For simplicity of explanation, the methods and/or computer-implemented methods are depicted and described as a series of acts. It is to be understood and appreciated that the disclosed subject matter is not limited by the acts illustrated and/or by the order of acts, for example acts can occur in various orders and/or concurrently, and with other acts not presented and described herein. Furthermore, not all illustrated acts can be required to implement the computer-implemented methods in accordance with the disclosed subject matter. In addition, those skilled in the art will understand and appreciate that the computer-implemented methods could alternatively be represented as a series of interrelated states via a state diagram or events. Additionally, it should be further appreciated that the computer-implemented methods disclosed hereinafter and throughout this specification are capable of being stored on an article of manufacture to facilitate transporting and transferring such computer-implemented methods to computers. The term article of manufacture, as used herein, is intended to encompass a computer program accessible from any computer-readable device or storage media.

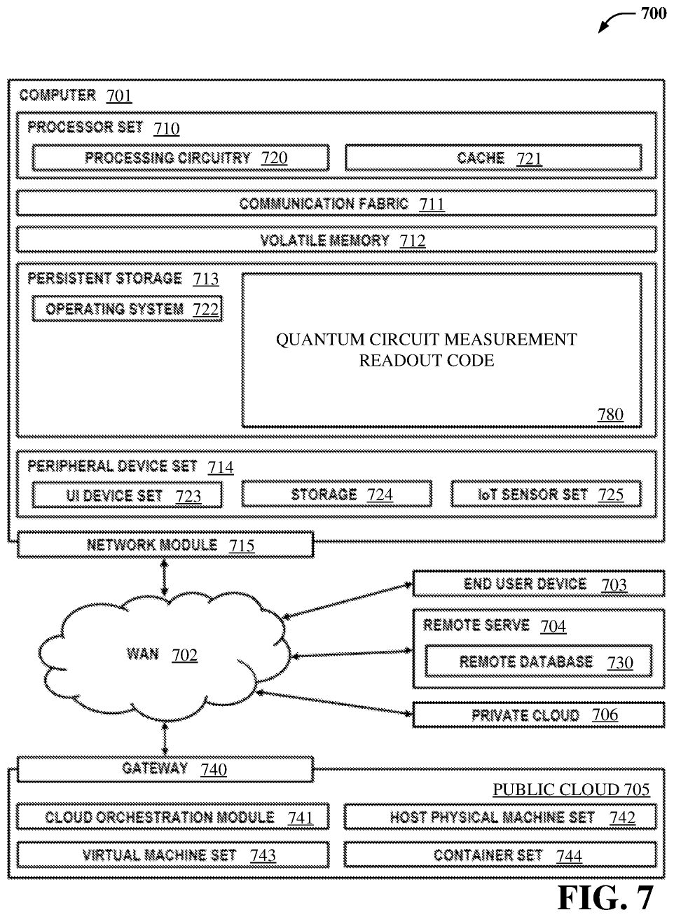

Turning next to FIG. 7, a detailed description is provided of additional context for the one or more embodiments described herein at FIGS. 1-6.

FIG. 7 and the following discussion are intended to provide a general description of a suitable computing environment 700 in which one or more embodiments described herein at FIGS. 1-6 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as translation of an original source code based on a configuration of a target system by the quantum circuit measurement readout code 780. In addition to block 780, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 780, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method can be distributed among multiple computers and/or between multiple locations. On the other hand, in this presentation of computing environment 700, detailed discussion is focused on a single computer, specifically computer 701, to keep the presentation as simple as possible. Computer 701 can be located in a cloud, even though it is not shown in a cloud in FIG. 7. On the other hand, computer 701 is not required to be in a cloud except to any extent as can be affirmatively indicated.

PROCESSOR SET 710 includes one, or more, computer processors of any type now known or to be developed in the future. Processing circuitry 720 can be distributed over multiple packages, for example, multiple, coordinated integrated circuit chips. Processing circuitry 720 can implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set can be located “off chip.” In some computing environments, processor set 710 can be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods can be stored in block 780 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory can be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 can be a read only memory (ROM), but typically at least a portion of the persistent storage allows writing of data, deletion of data and re-writing of data. Some familiar forms of persistent storage include magnetic disks and solid-state storage devices. Operating system 722 can take several forms, such as various known proprietary operating systems or open-source Portable Operating System Interface type operating systems that employ a kernel. The code included in block 780 typically includes at least some of the computer code involved in performing the inventive methods.

PERIPHERAL DEVICE SET 714 includes the set of peripheral devices of computer 701. Data communication connections between the peripheral devices and the other components of computer 701 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 723 can include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 can be persistent and/or volatile. In some embodiments, storage 724 can take the form of a quantum computing storage device for storing data in the form of qubits. In embodiments where computer 701 is required to have a large amount of storage (for example, where computer 701 locally stores and manages a large database) then this storage can be provided by peripheral storage devices designed for storing large amounts of data, such as a storage area network (SAN) that is shared by multiple, geographically distributed computers. IoT sensor set 725 is made up of sensors that can be used in Internet of Things applications. For example, one sensor can be a thermometer and another sensor can be a motion detector.

NETWORK MODULE 715 is the collection of computer software, hardware, and firmware that allows computer 701 to communicate with other computers through WAN 702. Network module 715 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software- defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701) and can take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 can be a client device, such as thin client, heavy client, mainframe computer and/or desktop computer.

REMOTE SERVER 704 is any computer system that serves at least some data and/or functionality to computer 701. Remote server 704 can be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data can be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs can be stored as images and can be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware and firmware allowing public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud can be disconnected from the interne entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

One or more embodiments can be a system, a method, an apparatus and/or a computer program product at any possible technical detail level of integration. The computer program product can include a computer readable storage medium (or media) having computer readable program instructions thereon for causing a processor to carry out aspects of the one or more embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can include the following: a portable computer diskette, a hard disk, a RAM, a ROM, an erasable programmable read-only memory (EPROM or Flash memory), a SRAM, a portable CD-ROM, a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the disclosed subject matter can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the disclosed subject matter.

Aspects of disclosed subject matter are described herein with reference to flowchart illustrations and/or block diagrams of methods, apparatus (systems), and computer program products according to embodiments of the subject disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create method for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer- executable instructions of a computer program product that runs on a computer and/or computers, those skilled in the art will recognize that this disclosure also can be implemented in combination with other program modules. Generally, program modules include routines, programs, components, data structures, etc. that perform particular tasks and/or implement particular abstract data types. Moreover, those skilled in the art will appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other method to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include ROM, PROM, EPROM, EEPROM, flash memory, or nonvolatile RAM (e.g., FeRAM). Volatile memory can include RAM, which can act as external cache memory, for example. By way of illustration and not limitation, RAM is available in many forms such as SRAM, DRAM, SDRAM, DDR SDRAM, ESDRAM, SLDRAM, DRRAM, DRDRAM, and RDRAM. Additionally, the disclosed memory components of systems or computer-implemented methods herein are intended to include, without being limited to including, these and any other suitable types of memory.

What has been described above include mere examples of systems and computer- implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An electronic structure, comprising:
a first Superconducting Quantum Interference Device (SQUID) coupled between a first pad and a second pad of a first tunable coupler qubit (TCQ), and a first Josephson Junction (JJ) coupled between the second pad and a third pad of the first TCQ; and
a second SQUID coupled between a first pad and a second pad of a second TCQ, and a second JJ coupled between the second pad and a third pad of the second TCQ,
wherein the second pad of the first TCQ is coupled to the second pad of the second TCQ;
and the first TCQ is coupled to a first driveline; and the second TCQ is coupled to a second driveline.

2. The electronic structure of claim 1, wherein the first TCQ is coupled with the second TCQ via direct capacitive coupling.

3. The electronic structure of claim 1, wherein a coplanar waveguide resonator is coupled between the first TCQ and the second TCQ.

4. The electronic structure of claim 1, wherein the first TCQ includes a first oscillation mode and a second oscillation mode; the second TCQ includes a third oscillation mode and a fourth oscillation mode; and quantum information is capable of being stored in the first oscillation mode of the first TCQ and the third oscillation mode of the second TCQ.

5. The electronic structure of claim 4, wherein the first SQUID is flux-tunable via the first driveline, and the second SQUID is flux-tunable via the second driveline.

6. The electronic structure of claim 5, wherein the first SQUID includes a first plurality of JJs; the second SQUID includes a second plurality of JJs; a first sum of critical currents from the first plurality of JJs is substantially similar to a first critical current of the first JJ; and a second sum of critical currents from the second plurality of JJs is substantially similar to a second critical current of the second JJ.

7. The electronic structure of claim 6, wherein the second oscillation mode of the first TCQ is coupled to the fourth oscillation mode of the second TCQ.

8. The electronic structure of claim 7, wherein the first TCQ and the second TCQ are capable of performing a controlled phase gate.

9. An electronic system, comprising:
a first driveline coupled to a first tunable coupler qubit (TCQ) including a first qubit; and
a second driveline coupled to a second tunable coupler qubit (TCQ) including a second qubit,
wherein a first flux is applied to the first TCQ via the first driveline and a second flux is applied to the second TCQ via the second driveline such that a controlled phase gate is coupled between the first TCQ and the second TCQ.

10. The electronic system of claim 9, wherein the first TCQ includes a first oscillation mode and a second oscillation mode; the second TCQ includes a third oscillation mode and a fourth oscillation mode; the electronic system is in a first state when the first driveline does not apply the first flux to the first TCQ and the second driveline does not apply the second flux to the second TCQ; and the electronic system is in a second state when the second flux is applied to the second TCQ such that a frequency of the third oscillation mode of the second TCQ is substantially similar to a transition frequency of the first TCQ.

11. The electronic system of claim 10, wherein the electronic system is in a third state when the first flux is applied to the first TCQ and the second flux is applied to the second TCQ such that there is a ZZ interaction between the first TCQ and the second TCQ.

12. The electronic system of claim 11, wherein the first TCQ includes a first SQUID coupled between a first pad and a second pad of the first TCQ, and a first JJ coupled between the second pad and a third pad of the first TCQ; the second TCQ includes a second SQUID coupled between a first pad and a second pad of the second TCQ, and a second JJ coupled between the second pad and a third pad of the second TCQ.

13. The electronic system of claim 12, wherein the first TCQ wherein in the third state, the first oscillation mode of the first TCQ and the third oscillation mode of the second TCQ each store quantum information.

14. A method of coupling a plurality of multi-mode qubits, comprising:
longitudinally coupling a first tunable coupler qubit (TCQ) with a second tunable coupler qubit (TCQ) to form a ZZ connection therebetween by operating the first TCQ at a first flux via a first driveline and operating the second TCQ at a second flux via a second driveline, wherein the first TCQ and the second TCQ have direct capacitive coupling between a first middle pad of the first TCQ and a second middle pad of the second TCQ.

15. The method of claim 14, wherein the first TCQ includes a first oscillation mode and a second oscillation mode; the second TCQ includes a third oscillation mode and a fourth oscillation mode; and the second oscillation mode of the first TCQ is coupled to the fourth oscillation mode of the second TCQ.

16. The method of claim 15, wherein the first oscillation mode of the first TCQ and the third oscillation mode of the second TCQ each store quantum information.

17. The method of claim 16, further comprising:
applying a flux, via the first driveline, to a first SQUID of the first TCQ to decrease a frequency of the first oscillation mode and the second oscillation mode of the first TCQ.

18. The method of claim 16, further comprising:
applying a flux, via the first driveline, to a first SQUID of the first TCQ to lower a Josephson energy of the first SQUID and to change a spatial configuration of the first oscillation mode and the second oscillation mode of the first TCQ.

19. The method of claim 18, further comprising:
applying the second flux, via the second driveline, to a second SQUID of the second TCQ such that a frequency of the third oscillation mode of the second TCQ is substantially similar to a transition frequency of the first TCQ.

20. The method of claim 19, wherein a controlled-phase gate is coupled between the first TCQ and the second TCQ.
